(19) United States
(12) Patent Application Publication
(10) Pub. No.: US 2015/0182779 A1
(43) Pub. Date: Jul. 2, 2015

(54) Cable Attachment Release Mechanism

(71) Applicant: ICON HEALTH & FITNESS, INC., LOGAN, UT (US)

(72) Inventor: William T. Dalebout, North Logan, UT (US)

(21) Appl. No.: 14/299,639

(22) Filed: Jun. 9, 2014

Related U.S. Application Data
(60) Provisional application No. 61/922,654, filed on Dec. 31, 2013.

(51) Int. Cl. A63B 21/00; F16G 11/03

(52) U.S. Cl. CPC A63B 21/152; F16G 11/03

(57) ABSTRACT

A release assembly includes a first part supporting a first locking member and a second locking member. A second part of the release assembly includes a receptacle shaped to interlock with the first locking member and the second locking member. The first locking member includes a first interlocking feature, and the second locking member includes a second interlocking feature. An urging mechanism is configured to move the first interlocking feature to interlock with the receptacle and to move the second interlocking feature to interlock with the receptacle. The first locking member and the second locking member are arranged to disengage from the receptacle of the second part in response to an inward force applied to the first and second locking members.

### RELATED APPLICATIONS

This application claims priority to U.S. Provisional Application No. 61/922,654, entitled Cable Attachment Release Mechanism, filed on Dec. 31, 2013; which is incorporated herein in its entirety by this reference.

### BACKGROUND

While there are numerous exercise activities that one may participate in, exercise may be broadly broken into the categories of aerobic exercise and anaerobic exercise. Aerobic exercise generally refers to activities that substantially increase the heart rate and respiration of the exerciser for an extended period of time. This type of exercise is generally directed to enhancing cardiovascular performance. Such exercise usually includes low or moderate resistance to the movement of the individual. For example, aerobic exercise includes activities such as walking, running, jogging, swimming or bicycling for extended distances and extended periods of time.

Anaerobic exercise generally refers to exercise that strengthens skeletal muscles and usually involves the flexing or contraction of targeted muscles through significant exertion during a relatively short period of time and/or through a relatively small number of repetitions. For example, anaerobic exercise includes activities such as weight training, push-ups, sit-ups, pull-ups, or a series of short sprints.

To build skeletal muscle, a muscle group is contracted against resistance. The contraction of some muscle groups produces a pushing motion, while the contraction of other muscle groups produces a pulling motion. A cable machine is a popular piece of exercise equipment for building those muscle groups that produce pulling motions. A cable machine often includes a cable with a handle connected to a first end and a resistance mechanism connected to a second end. Generally, the resistance mechanism is an selectable set of weights. A midsection of the cable is supported with at least one pulley. To move the cable, a user pulls on the handle with a force sufficient to overcome the force of the resistance mechanism. As the cable moves, the pulley or pulleys direct the movement of the cable and carry a portion of the resistance mechanism's load.

One type of cable exercise machine is disclosed in U.S. Pat. No. 7,077,793 issued to Ying-ching Wu. In this reference, a pull exerciser includes a handle, an attachment member having a tubular portion and a loop portion, a resilient cord having an end attached to the tubular portion of the attachment member, and a belt extending through a through-hole of the handle and the loop portion of the attachment member. The tubular portion of the attachment member has an engaging hole through which the end of the resilient cord extends. A stop is embedded in the end of the resilient cord and partially inserted into the engaging hole of the tubular portion of the attachment member, thereby preventing the end of the resilient cord from disengaging from the tubular portion of the attachment member. Other types of cable exercise machines are described in U.S. Pat. No. 6,524,226 issued to Stephen Kushner and U.S. Pat. No. 8,500,358 issued to John M. Cassidy.

### SUMMARY

In one aspect of the disclosure, a release assembly includes a first part supporting a first locking member and a second locking member.

In one aspect of the disclosure, a release assembly includes a second part comprising a receptacle shaped to interlock with the first locking member and the second locking member.

In one aspect of the disclosure, the first locking member comprising a first interlocking feature and the second locking member comprising a second interlocking feature.

In one aspect of the disclosure, the release assembly includes an urging mechanism to selectively move the first interlocking feature to interlock with the receptacle and to move the second interlocking feature to interlock with the receptacle

In one aspect of the disclosure, the first locking member and the second locking member are arranged to disengage from the receptacle of the second part in response to an inward force applied to the first locking member and the second locking member

In one aspect of the disclosure, the urging mechanism is a compression spring with a first end attached to the first locking member and a second end attached to the second locking member.

In one aspect of the disclosure, the first end of the compression spring is attached within a first recess formed in the first locking member and the second end of the compression spring is attached within a second recess formed in the second locking member.

In one aspect of the disclosure, the first locking member and the second locking member are attached to the first part with a pivot shaft.

In one aspect of the disclosure, the inward force causes at least one of the first locking member or the second locking member to rotate about the pivot shaft.

In one aspect of the disclosure, the release assembly includes a first gripping region is formed on the first locking member and a second gripping region is formed on the second locking member.

In one aspect of the disclosure, the first locking member comprises a first increased cross sectional thickness at the first gripping region and the second locking member comprises a second increased cross sectional thickness at the second gripping region.

In one aspect of the disclosure, the release assembly includes at least one of the first part or the second part is shaped to attach to a cable end.

In one aspect of the disclosure, the release assembly includes a central axis where an opening is formed in the second part along the central axis and the opening extends from an outer surface of the second part to the receptacle.

In one aspect of the disclosure, the opening comprises a cross sectional width that is smaller than a cable anchor positioned with the receptacle and attached to a cable end.

In one aspect of the disclosure, the first part or the second part is attached to a handle.

In one aspect of the disclosure, the first part or the second part is attached to a cable of an exercise machine.

In one aspect of the disclosure, the exercise machine is a treadmill.

In one aspect of the disclosure, the exercise machine includes a resistance mechanism.

In one aspect of the disclosure, the receptacle includes a circular rim.

In one aspect of the disclosure, the first part includes a housing that extends before gripping regions of the first and/or second locking members.

In one aspect of the disclosure, a release assembly includes a first part supporting a first locking member and a second locking member.

In one aspect of the disclosure, the first locking member comprising a first interlocking feature and the second locking member comprising a second interlocking feature.

In one aspect of the disclosure, the release assembly includes an urging mechanism to move the first interlocking feature to interlock with a receptacle of a second part and to move the second interlocking feature to interlock with the receptacle.

In one aspect of the disclosure, the first locking member and the second locking member are arranged to disengage from the receptacle of the second part in response to an inward force applied to the first locking member and the second locking member.

In one aspect of the disclosure, the urging mechanism has a first end attached to the first locking member and a second end attached to the second locking member.

In one aspect of the disclosure, the first locking member and the second locking member are attached to the first part with a pivot shaft.

In one aspect of the disclosure, the inward force causes the at least one of the first locking member or the second locking member to rotate about the pivot shaft.

In one aspect of the disclosure, the second part with the receptacle shaped to interlock with the first locking member and the second locking member.

In one aspect of the disclosure, the opening comprises a cross sectional width that is smaller than a cable anchor positioned with the receptacle and attached to a cable end.

In one aspect of the disclosure, the first part is shaped to attach to a cable end.

In one aspect of the disclosure, a release assembly includes a first part supporting a first locking member and a second locking member.

In one aspect of the disclosure, the release assembly includes a second part comprising a receptacle shaped to interlock with the first locking member and the second locking member.

In one aspect of the disclosure, the first locking member comprising a first interlocking feature and the second locking member comprising a second interlocking feature.

In one aspect of the disclosure, the release assembly includes an urging mechanism to move the first interlocking feature to interlock with the receptacle and to move the second interlocking feature to interlock with the receptacle.

In one aspect of the disclosure, the first locking member and the second locking member are arranged to disengage from the receptacle of the second part in response to an inward force applied to the first locking member and the second locking member.

In one aspect of the disclosure, the urging mechanism has a first end attached to the first locking member and a second end attached to the second locking member.

In one aspect of the disclosure, the first locking member and the second locking member are attached to the first part with a pivot shaft.

In one aspect of the disclosure, the inward force causes the at least one of the first locking member or the second locking member to rotate about the pivot shaft.

In one aspect of the disclosure, the release assembly includes a first gripping region is formed on the first locking member and a second gripping region is formed on the second locking member.

In one aspect of the disclosure, the release assembly includes a central axis where an opening is formed in the second part along the central axis and the opening extends from an outer surface of the second part to the receptacle.

In one aspect of the disclosure, the opening comprises a cross sectional width that is smaller than a cable anchor positioned with the receptacle and attached to a cable end.

Any of the aspects of the invention detailed above may be combined with any other aspect of the invention detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a front perspective view of an example of a cable exercise machine in accordance with the present disclosure.

FIG. 2 illustrates a perspective view of an example of a release assembly in accordance with the present disclosure.

FIG. 3 illustrates a side view of the release assembly of FIG. 2.

FIG. 4 illustrates a cross sectional view of the release assembly of FIG. 2.

FIG. 5 illustrates a perspective view of a release assembly in accordance with the present disclosure.

FIG. 6 illustrates a side view of the release assembly of FIG. 5.

FIG. 7 illustrates a cross sectional view of the release assembly of FIG. 5.

FIG. 8 illustrates a cross sectional view of a release assembly in accordance with the present disclosure.

FIG. 9 illustrates a cross sectional view of a release assembly in accordance with the present disclosure.

FIG. 10 illustrates a perspective view of an example of a release assembly in accordance with the present disclosure.

FIG. 11 illustrates a cross sectional view of an example of a release assembly with a first part interconnected with a second part in accordance with the present disclosure.

FIG. 12 illustrates a cross sectional view of an example of a release assembly with a first part disconnected from a second part in accordance with the present disclosure.

FIG. 13 illustrates a perspective view of an example of a second part of a release assembly disposed within an opening in accordance with the present disclosure.

FIG. 14 illustrates a perspective view of an example of a release assembly incorporated into a treadmill in accordance with the present disclosure.

Throughout the drawings, identical reference numbers designate similar, but not necessarily identical, elements.

### DETAILED DESCRIPTION

Different muscles groups can be worked during a pull exercise based on the angle of the user's arms. For example, if a user pulls a cable towards his chest with his arms spread out wide, the user's back muscles are worked. On the other hand, if the user pulls the cable towards his chest with his arms close together, more of the user's arm muscles are worked. A user can use different handles attached to the cable of the cable exercise machine to achieve the desired width for each pull. For example, the user may attach a long handle to the cable's end at the handle's center to perform a wide grip pull. On the other hand, the user may attach a much shorter attachment to perform a close grip pull. The user may desire to do exercises with both wide and close grips during a workout routine. As a result, the user may desire to switch the handle attached to the cable's end.

The principles described in the present disclosure include a release assembly that allows for a quick release of an attachment to a cable. Such a release assembly includes a first part supporting a first locking member and a second locking member. The second part includes a receptacle that is shaped to interlock with the first and second locking members. Both the first and second locking members include locking features that are shaped to interlock with the receptacle. An urging mechanism is configured to move the features of the first and second locking members to interlock with the receptacle. The locking members can be moved to release their interlocking features from the receptacle by applying an inward force to the locking members.

In some examples, the inward force can be generated by pinching the release assembly such that the first and second locking members move inward. In some examples, just one of the first or second locking members can move inward to cause the release. The locking members may be shaped to facilitate the generation of the inward force. For example, the locking members may include gripping regions that include enlarged cross sectional thicknesses so that the gripping regions are positioned near the outside of the release assembly. In such examples, the gripping regions can be spaced to accommodate the user's thumb and index finger for pinching the gripping regions.

Any appropriate type of urging member may be used in accordance with the principles described in the present disclosure. In some examples, the urging mechanism is a compression spring that is arranged to push the first interlocking feature to interlock with the receptacle. Likewise, the same compression spring may also be arranged to push the second interlocking feature of the second locking member to interlock with the receptacle.

With reference to this specification, terms such as “upper,” “lower,” and similar terms that are used with reference to components of the cable exercise machine are intended to described relative relationships between the components being described. Such terms generally depict the relationship between such components as though the cable exercise machine were standing in the intended upright position for proper use. For example, the term “lower” may refer to those components of the cable exercise machine that are located relatively closer to the base of the cable exercise machine than another component. Likewise, the term “upper” may refer to those components of the cable exercise machine that are located relatively farther away from the base of the cable exercise machine. Such components that are described with “upper,” “lower,” or similar terms do not lose their relative relationships just because the cable exercise machine is temporarily on one of its sides for shipping, storage, or during manufacturing.

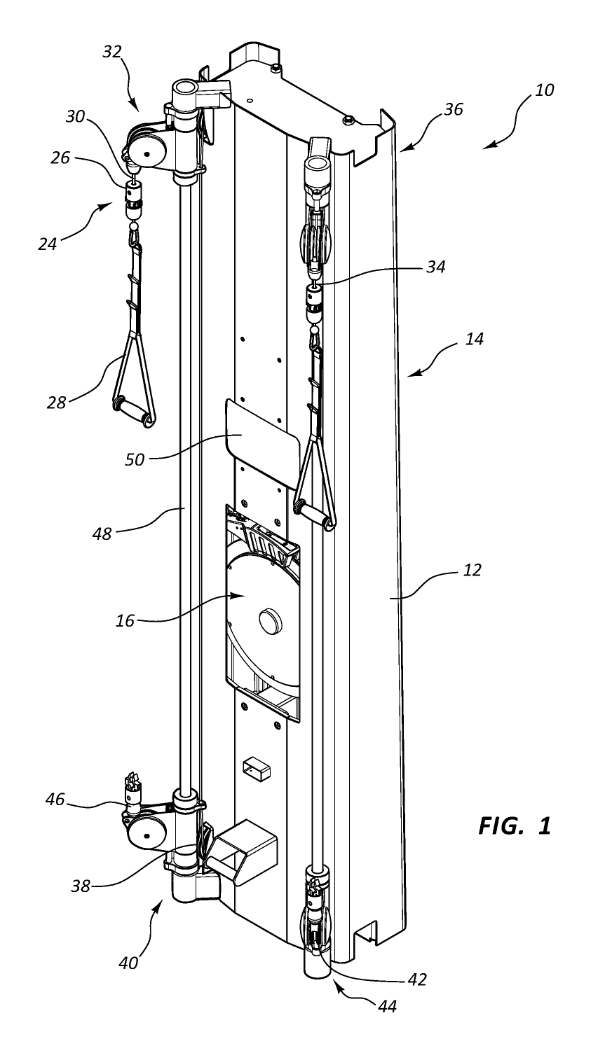

Particularly, with reference to the figures, FIG. 1 depicts a cable exercise machine 10 with an outer covering 12 about a tower 14 which supports the cables. In the example of FIG. 1, a resistance mechanism, such as a flywheel assembly 16, is positioned in the middle of the tower 14 which includes a flywheel, a spool subassembly, and a central shaft. However, in other examples, the resistance mechanism may include a selectable stack of weight plates, an elastomeric member, another type of resistance mechanism, or combinations thereof. The resistance mechanism is connected to multiple cables. The cables are routed through multiple locations within the tower 14 with an arrangement of pulleys that direct the movement of the cables, counterweights, and the components of the resistance mechanism.

At least some of the cables have a handle end 24 that is equipped with a cable connector 26 that is configured to secure a handle 28 or another type of gripping device for pulling the cables. The pulleys route the handle ends 24 of a first cable 30 to an upper right location 32 of the tower 14, a second cable 34 to an upper left location 36 of the tower 14, a third cable 38 to a lower right location 40 of the tower 14, and a fourth cable 42 to a lower left location 44 of the tower 14. Each of these cables 30, 34, 38, 42 may be pulled against the resistance of the resistance mechanism.

The cable connectors 26 may be any appropriate type of connector for connecting a handle 28 to a cable. In some examples, at least one of the cable connectors 26 includes release assembly with a first part attached to a second part. The first part and the second part may be released from one another through any appropriate mechanism. In one example of an appropriate releasing assembly of the cable connector 26, the releasing assembly includes gripping regions that are configured to be pinched inward. Such an inward force causes the first part and the second part to unhook from one another. As a result, the first part is freed from the second part. The release assembly allows the handle 28 to be replaced so that the user can change the type of grip or move the handle 28 to another cable connector located at a different position on the pull exercise machine 10.

The user can pull any combination of the cables 30, 34, 38, 42 as desired. For example, the user may use the first and second cables 30, 34 as a pair for exercises that involve muscle groups that produce downward motions. In other examples, the user may use the third and fourth 38, 42 cables as a pair for exercises that involve muscle groups that produce upwards motions. Further, the user may use the first and third cables 30, 38 as a pair. Likewise, the user may use the second and fourth cables 34, 42 as a pair. In general, the user may combine any two of the cables to use as a pair to execute a workout as desired. Also, the user may use just a single cable as desired to execute a workout.

In some embodiments, a stopper 46 is attached to the handle ends 24 of the cables 30, 34, 38, 42. The stopper 46 can include a large enough cross sectional thickness to stop the handle end 24 from being pulled into a pulley, an opening in the outer covering 12, or another feature of the cable exercise machine 10 that directs the movement of the cables.

Additionally, the precise location to where the cables 30, 34, 38, 42 are routed may be adjusted. For example, a guide bar 48 may be positioned on the cable exercise machine 10 that allows a pulley supporting the handle end 24 to move along the guide bar's length. Such adjustments may be made to customize the workout for the individual user's height and/or desired target muscle group.

Within the tower 14, the pull cables 30, 34, 38, 42 may be routed in any appropriate manner such that a pull force on one of the pull cables 30, 34, 38, 42 is against the resistance provided by the resistance mechanism. For example, each of the pull cables 30, 34, 38, 42 may have an end attached directly to the spool subassembly of a flywheel assembly. In other examples, each of the pull cables 30, 34, 38, 42 may have an end attached directly to an intermediate component that attaches to the spool subassembly. The movement of the pull cables 30, 34, 38, 42 in a first pulling direction, may cause the spool subassembly 18 to rotate in a first direction about the central shaft. Further, counterweights may be in communication with the spool subassembly and configured to rotate the spool subassembly in a second returning direction. Further, the pull cables 30, 34, 38, 42 may be routed with a single pulley or with multiple pulleys. In some examples, multiple pulleys are used to distribute the load to more than one location on the tower to provide support for the forces generated by a user pulling the pull cables 30, 34, 38, 42 against a high resistance. Further, at least one of the pulleys incorporated within the tower may be a tensioner pulley that is intended to reduce the slack in the cables so that the resistance felt by the user is consistent throughout the pull.

The cable exercise machine 10 may further includes a control panel 50 which may be incorporated into the outer covering 12 or some other convenient location. The control panel 50 may include various input devices (e.g., buttons, switches or dials) and output devices (e.g., LED lights, displays, alarms). The control panel 50 may further include connections for communication with other devices. Such input devices may be used to change a level of resistance, track calories, set a timer, play music, play an audiovisual program, provide other forms of entertainment, execute a pre-programmed workout, perform another type of task, or combinations thereof. A display can provide feedback to the user about his or her performance, the resistance level at which the resistance mechanism is set, the number of calories consumed during the workout, other types of information, or combinations thereof.

While this example has been described with reference to a specific cable exercise machine that incorporates a magnetic resistance mechanism, any appropriate type of resistance mechanism may be used. For example, the cable exercise machine may incorporate a stack of weight plates where the amount of resistance is selected by inserting a removable pin at a desired plate. In such an example, when the user pulls on the handles, the desired plate and all other plates above the desired plate move in a vertical direction based on the user's pull. In other examples, an elastomeric resistance device may be incorporated into the machine. In such an example, a material, such as an elastic band or elastic cord may resist the force generated by the user's pull.

Also, while the above examples have been described with reference to a specific cable exercise machine where the cables and resistance mechanism are supported by a tower, the cable exercise machine may include any appropriate type of support structure. For example, the pull exercise machine may be a portable machine that can be stuffed into a bag. In such an example, the pull exercise machine may include an elastic cable that has a first end that is configured to attach to the user's feet, another part of the user, a door frame, a weight bench, or another object. The user may pull on the cable with the handle, and the elasticity of the cable resists the user's movements. In some examples, the cable exercise machine includes a single pull cable. However, the cable exercise machine may incorporate any appropriate number of pull cables.

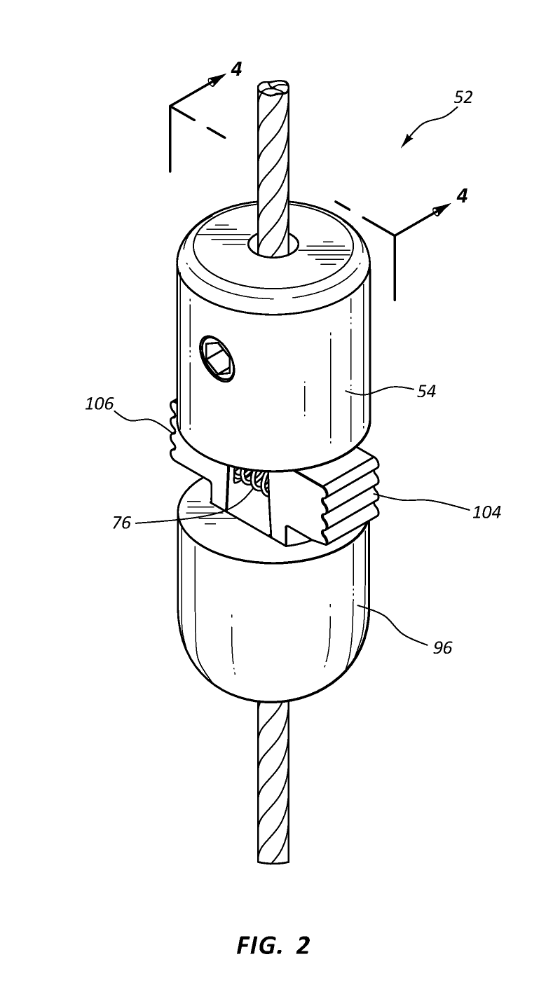

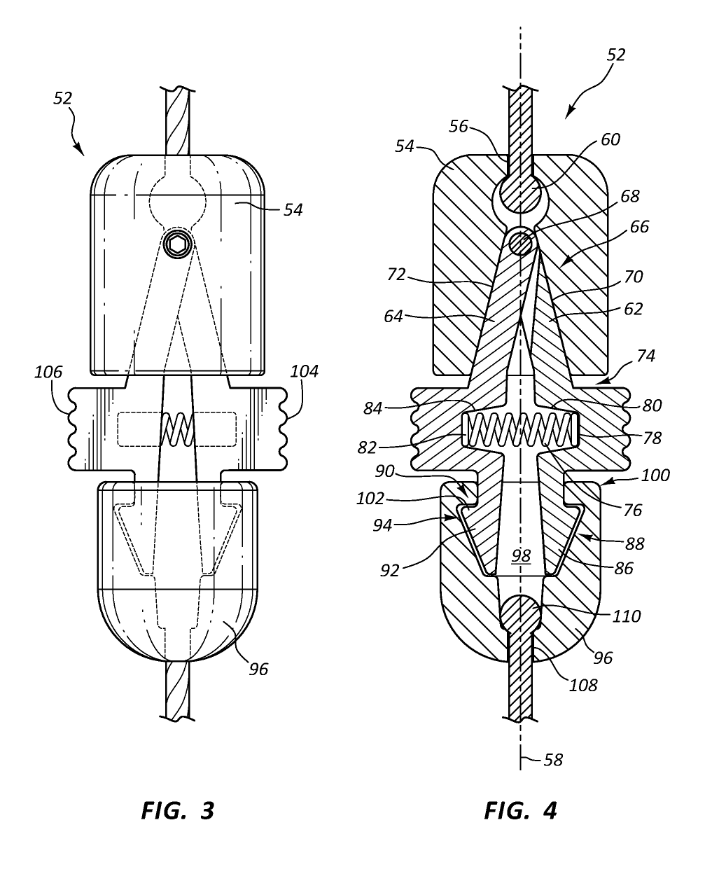

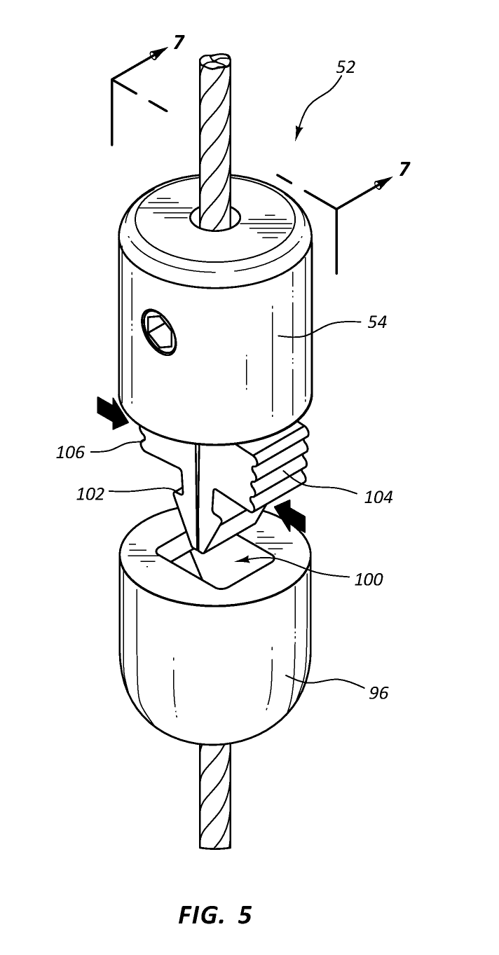

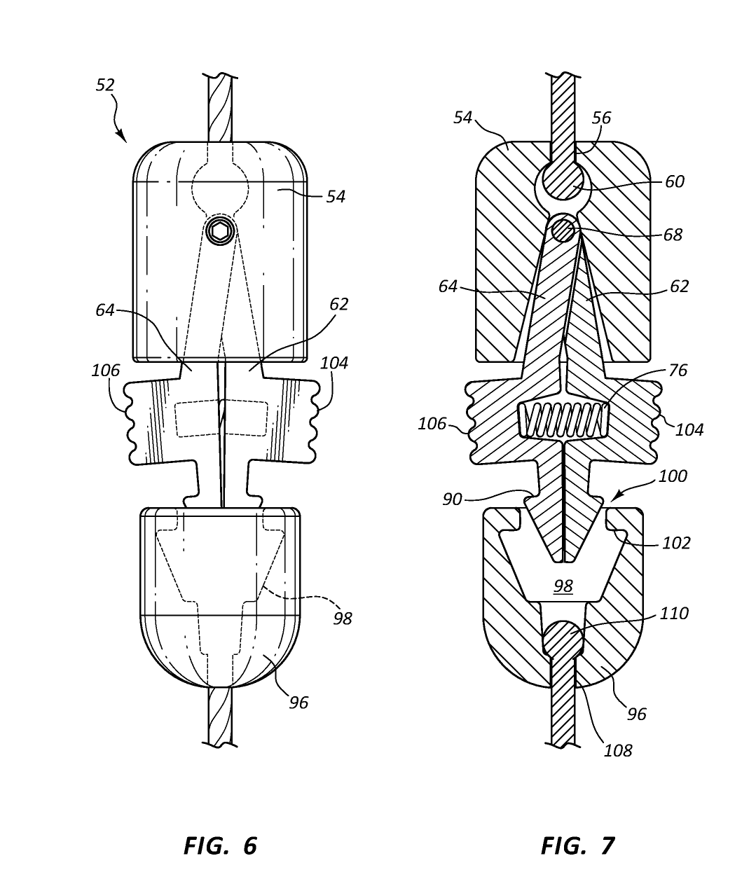

FIGS. 2-7 illustrate a release assembly 52 in accordance with the present disclosure. FIGS. 2-4 illustrate the release assembly with a first part 54 and a second part 96 interconnected while FIGS. 5-7 illustrate the first part 54 and the second part 96 freed from one another. In these examples, the release assembly 52 is integrated into a cable connector 26. A first part 54 of the release assembly 52 includes a first aperture 56 formed along a central axis 58 of the release assembly 52. The width of the first aperture 56 is wide enough to accommodate the diameter of a cable. However, the width of the first aperture 56 is narrower than a cross sectional thickness of the first anchor 60, which is rigidly attached to the cable. As a result, the first anchor 60 is unable to pass through the first aperture 56. Thus, the first anchor 60, and thereby the cable, is retained in the first part 54 when a pull force going down the cable is exerted.

The first part 54 also includes a first locking member 62 and a second locking member 64. Each of the first locking member 62 and the second locking member 64 include pivot ends 66, which are attached to a pivot shaft 68 retained in the first part 54 of the release assembly 52. The pivotal range of the first locking member 62 is restricted by a first internal wall 70 formed by the first part 54, and the pivotal range of the second locking member 64 is restricted by a second internal wall 72. The pivoting range of the first and second locking members 62, 64 are further restricted by an urging mechanism 74, which urges the first and second locking members 62, 64 towards the first and second internal walls respectively. Thus, in the absence of an inward force, the urging mechanism 74 causes the first and second locking members 62, 64 to be spread apart as much as the internal walls 70, 72 allow.

In the example of FIGS. 2-7, the urging mechanism 74 includes a compression spring 76. A first end 78 of the compression spring 76 is attached within a first recess 80 formed in the first locking member 62, and a second end 82 of the compression spring 76 is attached with a second recess 84 formed in the second locking member 64. In such examples, the compression spring 76 can apply a continuous force to spread the locking members 62, 64 apart. While this example has been described with specific reference to an urging mechanism with a compression spring, any appropriate type of urging mechanism may be used in accordance with the principles described herein. For example, the urging mechanism may include tension springs with an end attached to the internal wall that pulls the locking members, rather than pushing, towards the internal wall. In other examples, the urging mechanism includes an elastomeric material that is positioned to apply an outward force to the locking members pushing them towards the internal walls. In yet other examples, other features and characteristics of the urging member may be incorporated into the release assembly 52 to apply an outward force to the locking members.

The first locking member 62 includes a first distal end 86 with a first interlocking feature 88. In the example of FIGS. 2-7, the first interlocking feature 88 includes an overhanging surface 90. Likewise, the second locking member 64 includes a second distal end 92 with a second interlocking feature 94. In the example of FIGS. 2-7, the second interlocking feature 94 is also an overhanging surface 90. The force generated by the urging mechanism 74 may be overcome by an inward force that causes either or both of the first and second locking members 62, 64 to pivot inward about the pivot shaft 68. As the locking members 62, 64 move inward, the first and second distal ends 86, 92 move closer together into a release position.

The first locking member 62 and the second locking member 64 may be offset from one another such that the locking members 62, 64 can slide adjacent one another without interfering with the pivoting range of the other. In such an example, the locking members 62, 64 may be arranged like a pair of scissor blades. In some embodiments, the locking members 62, 64 are arranged such that the locking members 62, 64 are pushed into each other when the inward force is applied.

The second part 96 forms a receptacle 98, which includes a receptacle entrance 100. The width of the receptacle entrance 100 is wide enough to allow the first and second distal ends 86, 92 to enter the receptacle 98 when the locking members 62, 64 are in the release position. When the inward force exerted on the locking members 62, 64 is removed once the distal ends 86, 92 are within the receptacle, the locking members 62, 64 can be pushed outward by the compression spring 76 of the urging mechanism 74. The first internal wall 70 of the first part 54 is shaped to allow the first locking member 62 to pivot outward enough so that the first interlocking feature 88 interlocks with the receptacle 98. Likewise, the second internal wall 72 of the first part 54 is shaped to allow the second locking member 64 to pivot outward enough so that the second interlocking feature 94 also interlocks with the receptacle 98.

The receptacle 98 is shaped to interlock with the first and second interlocking features 88, 94 when the first and second locking members 62, 64 are in a locked position. The locking members 62, 64 are in the locked position when the compression spring 76 of the urging mechanism 74 causes the first and second locking members 62, 64 to spread apart. In the example of FIGS. 2-7, the receptacle forms catches 102, which catch the overhanging surfaces 90 and prevent the distal ends 86, 92 from existing the receptacle 98.

While the above example has been described with reference to a specific receptacle shape and interlocking features, any appropriate type of receptacle shape and interlocking features may be used in accordance with the principles described in the present disclosure. For example, the interlocking features may include a rod that is received by an opening formed in the receptacle. In other examples, the interlocking feature may include protrusions protruding downward from the overhanging surfaces that fits within a groove or other type of opening formed in the receptacle. Furthermore, the interlocking features of the distal ends may interlock with shelves, ledges, beams, or other shaped members of the receptacle.

The locking members 62, 64 may include gripping regions 104, 106 that are spaced to allow a user to pinch the gripping regions 104, 106 with a thumb and an index figure. In such examples, the gripping regions may be positioned along the length of the first and second locking members 62, 64. In some examples, the sections of the locking members 62, 64 proximate the gripping regions 104, 106 have increased cross sectional thicknesses such that the gripping regions 104, 106 extend beyond the outside surface of the first part 54 and/or the second part 96. In some examples, the gripping regions 104, 106 include features that increase friction between the user's skin and a surface of the gripping regions 104, 106. For example, the gripping regions 104, 106 may include a rough surface, a grooved surface, a patterned surface, a material embedded into or onto the surface, other features or characteristics, or combinations thereof.

The second part 96 of the release assembly 52 includes a second aperture 108 formed along the central axis 58 of the release assembly 52. The width of the second aperture 108 is wide enough to accommodate the diameter of a cable. However, the width of the second aperture 108 is narrower than a cross sectional thickness of a second anchor 110, which is rigidly attached to the cable. As a result, the second anchor 110 is unable to pass through the second aperture 108. Thus, the second anchor 110, and thereby the cable, is retained in second part 96 when a pull force going down the cable is exerted.

In some examples, the space between the distal ends 86, 92 of the first and second interlocking features 88, 94 is less than the width of the receptacle entrance 100. This space, along with the angled surfaces of the interlocking features 88, 94 allow a user to impart an insertion force on the locking members 62, 64 which overcomes the biasing force supplied by the compression spring 76 as the user pushes the first part 54 into the second part 96. This allows insertion of the locking members 62, 64 into the receptacle entrance 100 without the user having to actuate the gripping regions 104, 106. The locking members 62, 64 can snap into place when the catches 102 clear the overhang surfaces 90 and the compression spring 76 is allowed to expand.

The user can quickly attach handles and other engagement devices quickly and without the risk of pinching. When removal is desired, the gripping regions 104, 106 can be actuated to overcome the biasing force supplied by the compression spring 76, allowing the translation of the catches 102 past the overhang surfaces 90, which narrows the space between the distal ends 86, 92 such that the overall distance from side to side of the interlocking features 88, 94 is less than the width of the receptacle's entrance 100 and the first part 54 can be removed from the second part 96.

While the examples of FIGS. 2-7 have been described with reference to the release assembly being incorporated into a cable connector, the release assembly may be rigidly attached to components other than cables. For example, the release assembly may be incorporated into a handle body on one side of the release assembly and a cable on the other side of the release assembly. In yet other examples, the release assembly may be incorporated into other parts of exercise machines where cables are not used. For example, the release assembly may be used to attach a pull up bar grip to a pull up bar assembly. Furthermore, the release assembly may also be incorporated into a bicycles, stationary bikes, treadmills, ellipticals, stepper machines, dumb bells, ski bindings, automobiles, kayaks, boats, other forms of recreational equipment, other types of machines, or combinations thereof.

FIG. 8 illustrates a cross sectional view of a release assembly 52 in accordance with the present disclosure. In this example, the first locking member 62 and the second locking member 64 are rigidly attached to the first part 54. In such an example, the first and second locking members 62, 64 are made of a material with an inherent spring characteristic. The first locking member 62 and the second locking member 64 may be cantilever springs that cause the distal ends 86, 92 to spread out in the absence of an inward force. Alternatively, as illustrated in FIG. 8, the release assembly 52 may include a compliant mechanism, or a member that transfers an input force or displacement to another point through elastic body deformation.

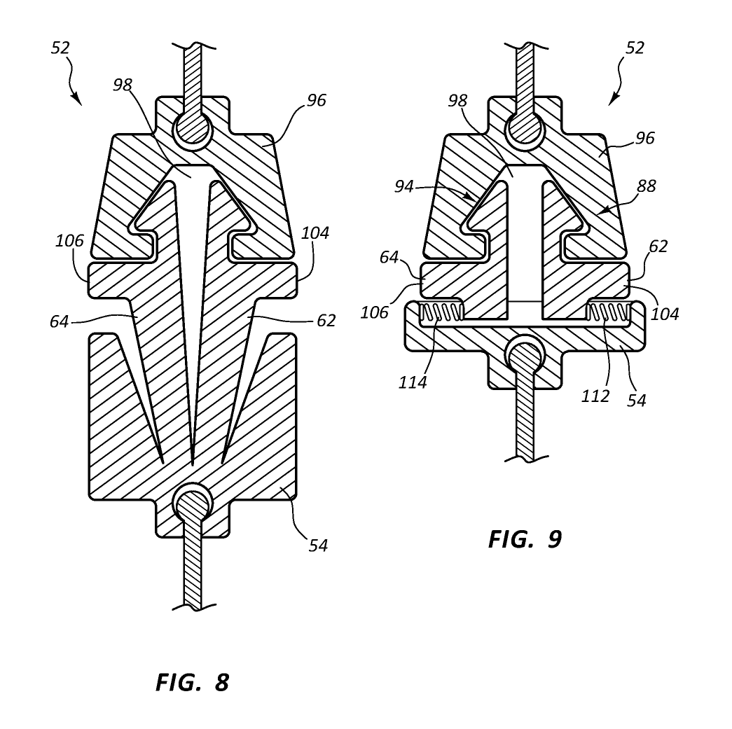

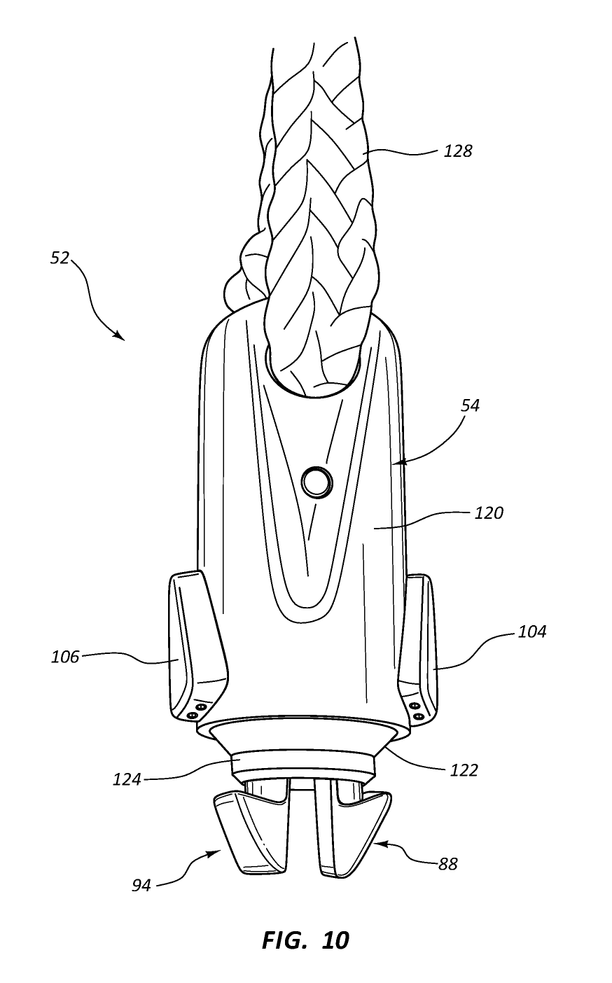

FIG. 9 illustrates a cross sectional view of a release assembly 52 in accordance with the present disclosure. In this example, the release assembly 52 includes an urging mechanism 74 with a first tension spring 112 attached to the first part 54 and the first locking member 62. Also, the urging mechanism 74 includes a second tension spring 114 attached to the first part 54 and the second locking member 64. The tension springs 112, 114 provide a continuous force to pull the first and second locking members 62, 64 apart from one another.

In the example of FIG. 9, the first and second locking members 62, 64 are situated on a track that is shaped to retain the first and second locking members 62, 64 connected to the first part 54 of the release assembly 52. In such an example, the user can pinch the gripping regions 104, 106 to provide the inward force that overcomes the force of the tension springs 112, 114 and moves the first and second locking members inward to release the interlocking features 88, 94 from the receptacle 98 of the second part 96.

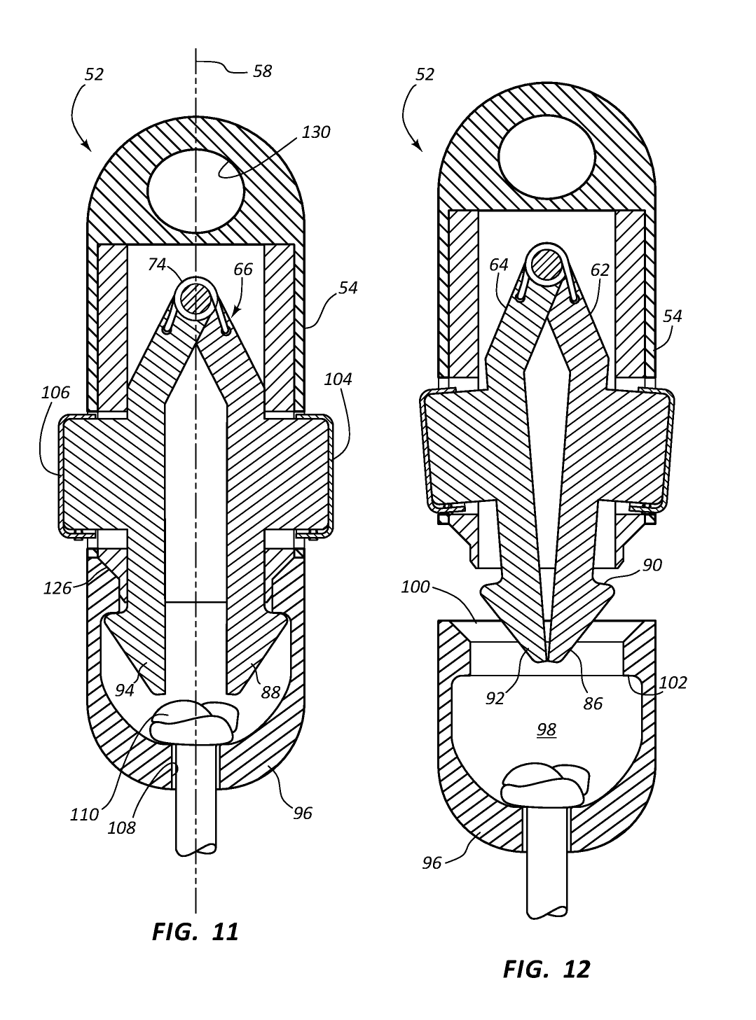

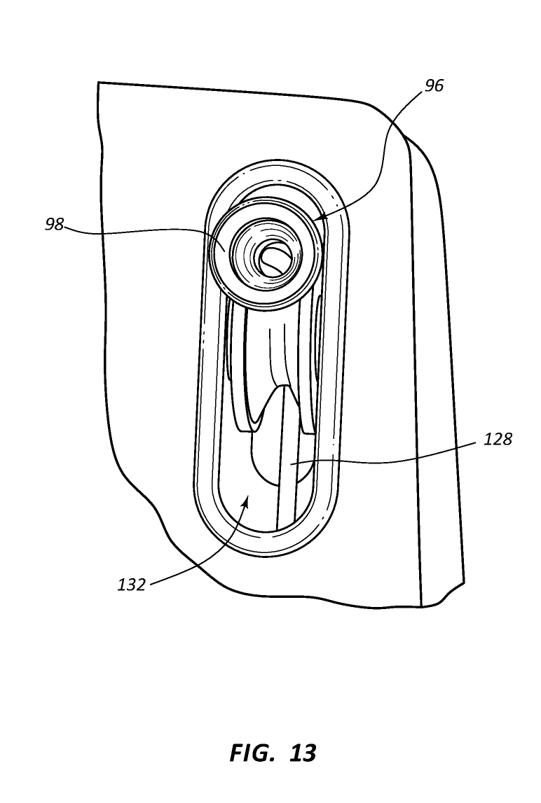

FIGS. 10-13 illustrate a perspective view of an example of a release assembly 52 in accordance with the present disclosure. In this example, the release assembly 52 includes a first part 54 with a housing 120 that extends beyond the gripping regions 104, 106. The housing 120 includes a taper 122 that narrows to a lip 124. In some examples, the taper 122 forms a mating shoulder that engages a rim 126 of the second part 96. The rim 126 may also include a tapered surface area. In some situations, the combination of the taper and the tapered surface area of the rim 126 align the first part 54 with the second part 96 as the first and second parts 54, 96 are interconnected.

In the illustrated example, the urging mechanism 74 urges the first and second locking member 62, 64 outward. In this example, the urging mechanism 74 is a torsion spring. In some cases, the lip 124 of the housing 120 may restrain the first and second locking members 62, 64 from spreading apart beyond a predetermined distance. In some cases, the lip 124 may provide the first and second members 62, 64 some protection from unexpected collisions with foreign objects.

The first part 54 may be connected to a cable 128 through a lateral aperture 130 that is formed transverse to a central axis 58. In some situations, the cable 128 may be threaded though the lateral aperture 130. The lateral aperture 130 can allow the first part 54 to slide along a length of the cable 128. In some examples, the cable may be tied into a knot, crimped together, or have a loop formed therein through a different mechanism. In some examples, the cable 128 has an anchor placed at the cable's end or positioned elsewhere along the length of the cable 128 that prevents the first part 54 from moving farther along the length of the cable 128.

The receptacle 98 may include a substantially circular rim 126 with a substantially circular catch 102 that can hook the overhanging surfaces 90 of the distal ends 86, 92. Thus, the distal ends 86, 92 of the first and second locking members 62, 64 may interlock with the receptacle 98 of the second part 96 regardless of the first part's azimuth. Thus, a user may not have to reorient the first part 54 with respect to the second part 96 when seeking to interlock the first and second part 54, 96 together.

In the example depicted in FIG. 13, the second part 96 is connected to a cable 128 that is threaded through an opening 132. The width of the second part 96 exceeds the width of the opening 132, thus, preventing the second part 96 from passing through the opening 132. In such an example, the second part 96 functions as a stopper to prevent the release assembly 52 from being pulled through the opening 132.

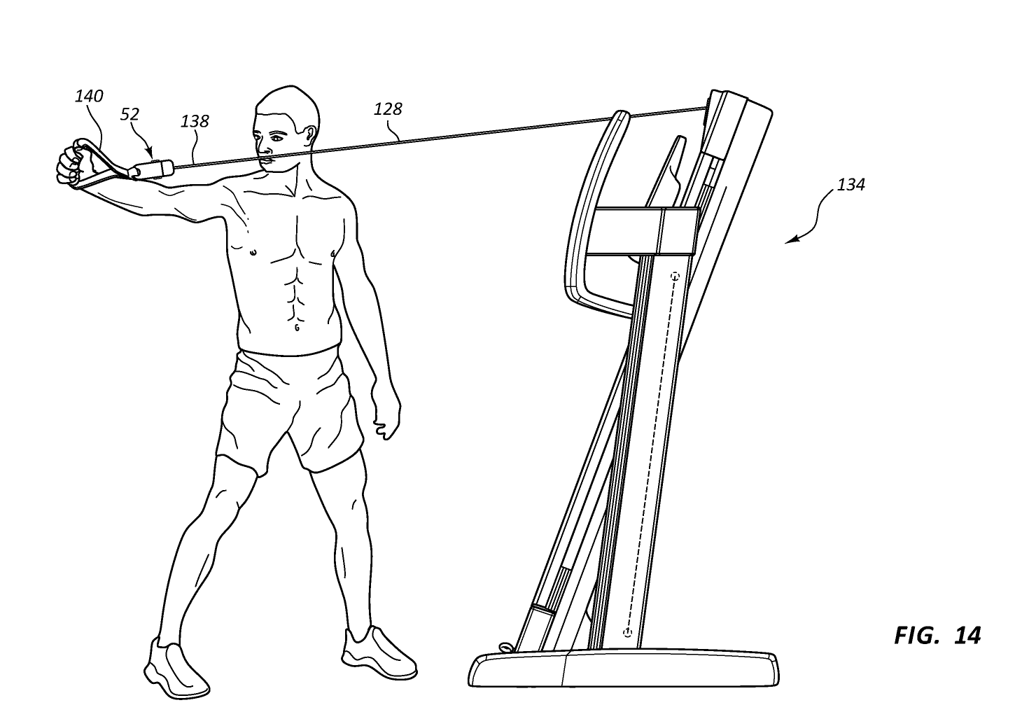

The opening 132 may be formed in any appropriate apparatus. In some examples, such an opening in formed in treadmill 134 as depicted in FIG. 14. In other examples, the opening 132 is formed in an exercise machine, an industrial machine, a crane assembly, a construction machine, a wrench assembly, a towing mechanism, a strap assembly, a fastening assembly, another type of apparatus, or combinations thereof.

The treadmill 134 may include a resistance mechanism incorporated into the running deck 136. A cable may be connected to the release assembly 52 at a pull end 138 of the cable 128 and to the resistance mechanism at a resistance end of the cable 128. A user can connect a handle 140 to the pull end 138 of the cable and pull the cable 128. As the user pulls the cable 128, the resistance mechanism can resist the force exerted by the user and allow the user to perform anaerobic exercises.

### INDUSTRIAL APPLICABILITY

In general, the invention disclosed herein may provide a user with the advantage of a release assembly that is intuitive for a user to operate. A user can easily and quickly attach and disconnect different hand grips, handles, and other types of accessories on cable exercise machines with a release assembly constructed based on the principles described in the present disclosure. The release mechanism provides an attachment that is sufficiently strong to withstand the forces exerted on a cable in a cable exercise machine while still allowing the connection to be easily released, for example, by a single hand.

Connections between a cable and a handle in a cable exercise machine are constructed to be robust enough to withstand creep, fatigue, and other forms of deformation, especially on those cable exercise machines where the users frequently lift heavy loads. The release assembly as described herein directs the loads to increase the useful life of the release assembly. For example, the locking members interlock with the receptacle under a side load produced by the urging member. The side load causes that the stresses generated from the pull force to be distributed to the surface area of the overhang. Such a stress distribution can spread the load and can reduce areas of high stress in the release assembly.

Further, the gripping regions are spaced so that a user can use his or her thumb to generate the inward force sufficient to free the first and second locking member from the second part. Also, the urging member can exert a side load that is sufficiently strong to keep the locking members interlocked with the second part, but not so strong that a user cannot overcome the side load with the typical force that can be generated with a human hand.

Further, the release assembly may be used in any appropriate type of exercise machine. In some examples, the release assembly is connected to a cable of a pull machine that allows the user to perform anaerobic exercises. Such an exercise machine may include a weight stack where a selected amount of weight is physically connected to a resistance end of the cable. As the user pulls the cable, the selected amount of weight moves with the resistance end of the cable. In other examples, the resistance mechanism may be a magnetic resistance mechanism. Such a magnetic resistance mechanism may include a magnetic force that resists the rotation of a flywheel. The flywheel's rotation and the magnetic force may be used to determine calorie counts, force exerted by the user, other parameters exerted by the user, or combinations thereof.

In some examples, the resistance mechanism is incorporated into a running deck of a treadmill. In such an example, openings formed in the running surface of the running deck may accommodate the pull ends of the cable while the rest of the pull cable and the resistance mechanism are located within the running deck. Such a configuration may allow the user to use the pull cable regardless of whether the running deck is raised to a storage orientation or laid down in a running orientation.

The running deck or other type of exercise machine may include multiple openings that accommodate different pull ends of cables. In such situations, the handle may be connectable with more than one of the pull ends. In some cases, the exercise machine may come with fewer handles than pull ends. With the release assembly described above, the user can connect the handle to the pull ends as desired.

What is claimed is:

1. A release assembly, comprising:
a first part supporting a first locking member and a second locking member;
a second part comprising a receptacle shaped to interlock with the first locking member and the second locking member;
the first locking member comprising a first interlocking feature and the second locking member comprising a second interlocking feature; and
an urging mechanism to selectively move the first interlocking feature to interlock with the receptacle and to move the second interlocking feature to interlock with the receptacle;
wherein the first locking member and the second locking member are arranged to disengage from the receptacle of the second part in response to an inward force applied to the first locking member and the second locking member.

2. The release assembly of claim 1, wherein the urging mechanism is a compression spring with a first end attached to the first locking member and a second end attached to the second locking member.

3. The release assembly of claim 2, wherein the first end of the compression spring is attached within a first recess formed in the first locking member and the second end of the compression spring is attached within a second recess formed in the second locking member.

4. The release assembly of claim 1, wherein the first locking member and the second locking member are attached to the first part with a pivot shaft.

5. The release assembly of claim 4, wherein the inward force causes at least one of the first locking member or the second locking member to rotate about the pivot shaft.

6. The release assembly of claim 1, wherein a first gripping region is formed on the first locking member and a second gripping region is formed on the second locking member.

7. The release assembly of claim 6, wherein the first locking member comprises a first increased cross sectional thickness at the first gripping region and the second locking member comprises a second increased cross sectional thickness at the second gripping region.

8. The release assembly of claim 1, wherein at least one of the first part or the second part is shaped to attach to a cable end.

9. The release assembly of claim 1, further comprising a central axis where an opening is formed in the second part along the central axis and the opening extends from an outer surface of the second part to the receptacle.

10. The release assembly of claim 9, wherein the opening comprises a cross sectional width that is smaller than a cable anchor positioned with the receptacle and attached to a cable end.

11. The release assembly of claim 1, wherein the first part or the second part is attached to a handle.

12. The release assembly of claim 1, wherein the first part or the second part is attached to a cable of an exercise machine.

13. The release assembly of claim 12, wherein the exercise machine is a treadmill.

14. The release assembly of claim 12, wherein the exercise machine includes a resistance mechanism.

15. The release assembly of claim 1, wherein the receptacle includes a circular rim.

16. The release assembly of claim 1, wherein the first part includes a housing that extends before gripping regions of the first and/or second locking members.

17. A release assembly, comprising:
a first part supporting a first locking member and a second locking member;
the first locking member comprising a first interlocking feature and the second locking member comprising a second interlocking feature;
an urging mechanism to move the first interlocking feature to interlock with a receptacle of a second part and to move the second interlocking feature to interlock with the receptacle;
the first locking member and the second locking member are arranged to disengage from the receptacle of the second part in response to an inward force applied to the first locking member and the second locking member;
the urging mechanism has a first end attached to the first locking member and a second end attached to the second locking member;
the first locking member and the second locking member are attached to the first part with a pivot shaft; and
wherein the inward force causes the at least one of the first locking member or the second locking member to rotate about the pivot shaft.

18. The release assembly of claim 17, further comprising the second part with the receptacle shaped to interlock with the first locking member and the second locking member.

19. The release assembly of claim 18, wherein the opening comprises a cross sectional width that is smaller than a cable anchor positioned with the receptacle and attached to a cable end.

20. The release assembly of claim 17, wherein the first part is shaped to attach to a cable end.

21. A release assembly, comprising:
a first part supporting a first locking member and a second locking member;
a second part comprising a receptacle shaped to interlock with the first locking member and the second locking member;
the first locking member comprising a first interlocking feature and the second locking member comprising a second interlocking feature;
an urging mechanism to move the first interlocking feature to interlock with the receptacle and to move the second interlocking feature to interlock with the receptacle;
the first locking member and the second locking member are arranged to disengage from the receptacle of the second part in response to an inward force applied to the first locking member and the second locking member;
the urging mechanism has a first end attached to the first locking member and a second end attached to the second locking member;
the first locking member and the second locking member are attached to the first part with a pivot shaft;
the inward force causes the at least one of the first locking member or the second locking member to rotate about the pivot shaft;
a first gripping region is formed on the first locking member and a second gripping region is formed on the second locking member;
a central axis where an opening is formed in the second part along the central axis and the opening extends from an outer surface of the second part to the receptacle; and
the opening comprises a cross sectional width that is smaller than a cable anchor positioned with the receptacle and attached to a cable end.
